(19) United States
(12) Patent Application Publication
(10) Pub. No.: US 2026/0169255 A1
(43) Pub. Date: Jun. 18, 2026

(54) OPTICAL APPARATUS AND IMAGE CAPTURING SYSTEM

(71) Applicant: CANON KABUSHIKI KAISHA, Tokyo (JP)

(72) Inventor: REMI IWAMOTO, Tochigi (JP)

(21) Appl. No.: 19/395,323

(22) Filed: Nov. 20, 2025

(30) Foreign Application Priority Data
Dec. 16, 2024 (JP) 2024-220093

(51) Int. Cl. G02B 7/14; G02B 7/02; G03B 17/14

(52) U.S. Cl. CPC G02B 7/14; G02B 7/021; G03B 17/14

(57) ABSTRACT

An optical apparatus comprises a holding unit configured to hold an optical element and to be movable in an optical axis direction, a guide unit configured to guide movement of the holding unit, and an urging member configured to urge the holding unit and the guide unit toward each other. The holding unit includes a first contact surface and a second contact surface that contact the guide unit in a direction perpendicular to the optical axis direction, a curvature of the first contact surface is smaller than a curvature of a third contact surface in the guide unit that contacts the first contact surface, and a curvature of the second contact surface is smaller than a curvature of a fourth contact surface in the guide unit that contacts the second contact surface.

### BACKGROUND

### Field of the Technology

The present disclosure relates to an optical apparatus and an image capturing system.

### Description of the Related Art

In order to suppress deterioration of optical performance due to an inclination of a lens with respect to a direction of an optical axis in various shooting postures, in Japanese Patent Application Laid-Open Publication No. 2010-197445, a structure is disclosed in which a guide bearing unit and a guide member are capable of coming into contact in a stable manner.

### SUMMARY

As one aspect of the present disclosure, an optical apparatus comprises: a holding unit configured to hold an optical element and to be movable in an optical axis direction; a guide unit configured to guide movement of the holding unit; and an urging member configured to urge the holding unit and the guide unit toward each other. The holding unit includes a first contact surface and a second contact surface that contact the guide unit in a direction perpendicular to the optical axis direction, a curvature of the first contact surface is smaller than a curvature of a third contact surface in the guide unit that contacts the first contact surface, and a curvature of the second contact surface is smaller than a curvature of a fourth contact surface in the guide unit that contacts the second contact surface.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image capturing system configured by a lens barrel and a camera body in a first embodiment.

FIG. 2 is an exploded perspective view of a fourth-group lens barrel and peripheral members in the first embodiment.

FIG. 3 is a front view of a configuration in which peripheral members are assembled to a fourth-group lens barrel in the first embodiment.

FIG. 4 is a front view showing a force acting on a fourth-group lens barrel in the first embodiment.

FIG. 5 is an enlarged view of contact points of a guide member and a linear guide unit in the first embodiment.

FIG. 6 is a front view showing a modified example of an urging unit and a drive unit for a guide member of a fourth-group lens barrel in the first embodiment.

FIG. 7 is a perspective view of a fourth-group lens barrel in a second embodiment.

FIG. 8 is a side view of a linear guide unit in the second embodiment.

FIG. 9 is an enlarged view of contact points of a guide member and a linear guide unit in the second embodiment.

FIG. 10 is a front view of a fourth-group lens barrel showing a disposition range of a linear guide unit in the second embodiment.

### DESCRIPTION OF THE EMBODIMENTS

Hereinafter, embodiments will be explained in detail with reference to the attached drawings. It should be noted that the following embodiments do not limit the disclosure according to the claims. Although a plurality of features are described in the embodiments, all of the plurality of features are not necessarily essential to the disclosure, and the plurality of features may be combined arbitrarily. Furthermore, in the attached drawings, identical reference numerals are assigned to identical or similar configurations, and duplicated explanation is omitted.

### First Embodiment

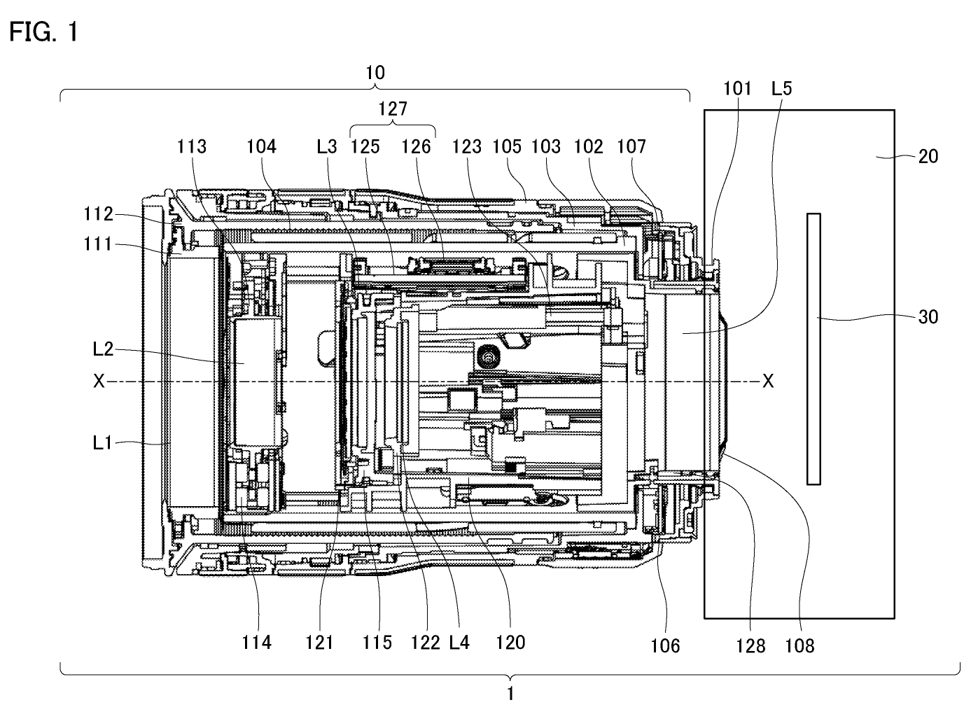

FIG. 1 is a cross-sectional view of an image capturing system 1 in a first embodiment. As shown in FIG. 1, the image capturing system 1 is configured so as to have a lens barrel (optical apparatus, lens apparatus) 10 and a camera body (image capturing apparatus) 20. A dash-dot line in the figure represents an optical axis X.

The camera body 20 has an image capturing element 30, and has a configuration that enables shooting of an image formed through the lens barrel 10. The lens barrel 10 is provided with a mount (mount unit) 101, and is configured to be mountable on the mount (not shown) of the camera body 20 (can be connected and fixed). In the present embodiment, the lens barrel 10 and the mount 101 function as an interchangeable lens. By mounting the mount 101 of the lens barrel 10 on the mount of the camera body 20, the lens barrel 10 can be communicably connected to the camera body 20.

A guide cylinder 102 and a fixed cylinder 103 are integrally fixed to the mount 101. A cam ring 104 is rotatably held on an outer circumference of the guide cylinder 102 about the optical axis. The cam ring 104 is connected to a zoom ring 105, which is rotatably held on the outer circumference of the guide cylinder 102, by a key member (not shown), and has a configuration in which, by operating the zoom ring 105 from the outside, the cam ring 104 rotates integrally. A zoom sensor (not shown) is attached to the fixed cylinder 103, and is a sensor capable of electrically detecting a rotation angle of the zoom ring 105. The zoom sensor is electrically connected to a control board (control unit) 106 disposed in the vicinity of the mount 101, and transmits focal length information during zooming to a control circuit.

The control board 106 is at least one computer including a CPU and memory, and performs control of the lens barrel 10 and the image capturing system 1 by executing a control program stored in a memory (not shown). The control board 106 performs control of the image capturing system 1 by communicating with a control board (not shown) on the camera body 20 side. That is, the control board 106 can perform control of the image capturing system 1 by receiving a predetermined control signal from the control board on the camera body 20 side and by executing a control program stored in a memory (not shown). A contact block 107 is electrically connected to the control board 106, and has a function of communication with the camera body 20 and of receiving power supply.

A first-group lens L1 is fixed to a first-group lens barrel 111. The first-group lens barrel 111 is fixed to a linear cylinder 112.

A second-group lens L2 is held by a second-group lens barrel 113, and the second-group lens barrel 113 is movably held by a shift unit 114 in a plane orthogonal to the optical axis. The shift unit 114 includes an actuator for driving the second-group lens barrel 113, a sensor for detecting a drive amount, and the like, and is fixed to the guide cylinder 102. The shift unit 114 is electrically connected to the control board 106. The control board 106 performs drive control of the second-group lens barrel 113 so as to correct shake based on a shake signal detected by an angular velocity sensor (not shown) attached to the fixed cylinder 103.

A third-group lens L3 is held by a third-group lens barrel 115, and is fixed to a third-group base lens barrel 120. An electromagnetic diaphragm unit 121 is held by the third-group base lens barrel 120, and is electrically connected to the control board 106.

A lens (optical element) included in a fourth-group lens (moving lens group, lens group) L4 is held by a fourth-group lens barrel (holding unit) 122, and the fourth-group lens barrel 122 is movably held by a guide member 123 to be described later with respect to the third-group base lens barrel 120 in the optical axis X direction (along the optical axis direction). Guide members 123 include a guide member (guide unit) 123a and a guide member 123b. It should be noted that each guide member 123 may be formed integrally with a base member (not shown) rather than as a separate member, or may be, for example, a cylindrical portion provided on the base member. The fourth-group lens L4 is a lens for focus adjustment, and is driven in the optical axis X direction by a linear ultrasonic motor 127 held by the third-group base lens barrel 120.

The linear ultrasonic motor 127 is composed of a fixed portion 125 and a movable portion 126, and is an actuator (drive unit) that drives the movable portion 126 in the optical axis X direction by causing a piezoelectric element to ultrasonically vibrate. The piezoelectric element is electrically connected to the control board 106 using a flexible printed circuit board (not shown).

A fifth-group lens L5 is held by a fifth-group lens barrel 128. The first-group lens L1, the third-group lens L3, and the fifth-group lens L5 are lenses that move during zooming, and cam followers (not shown) are fixed to the linear cylinder 112, the third-group base lens barrel 120, and the fifth-group lens barrel 128. Each cam follower is engaged with a linear groove provided in the guide cylinder 102 and a cam groove provided in the cam ring 104, and is configured so that, by rotating the cam ring 104, each cam follower can linearly move in the optical axis X direction.

In addition, the fourth-group lens L4 for focus adjustment is held by the third-group base lens barrel 120, and therefore is driven in the optical axis X direction by the linear ultrasonic motor 127 while moving together with the third-group base lens barrel 120 during zooming.

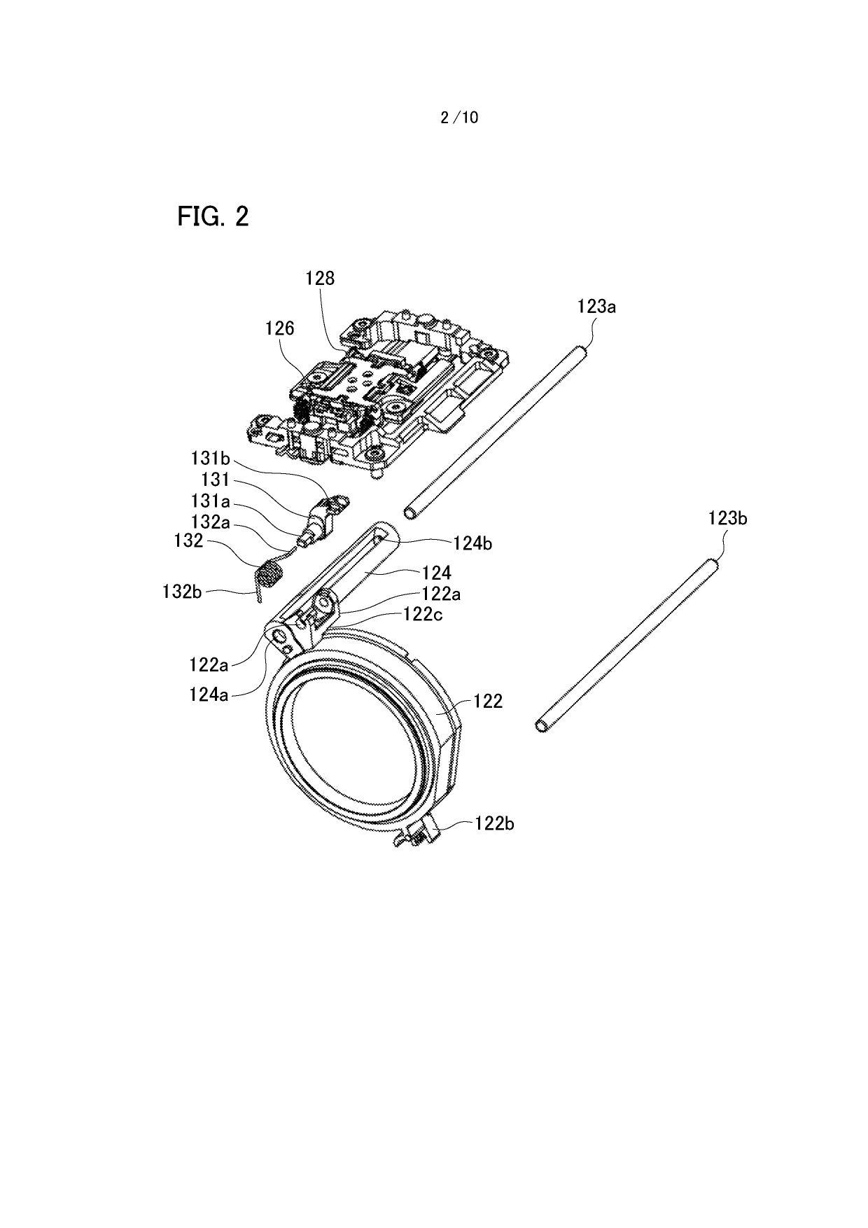

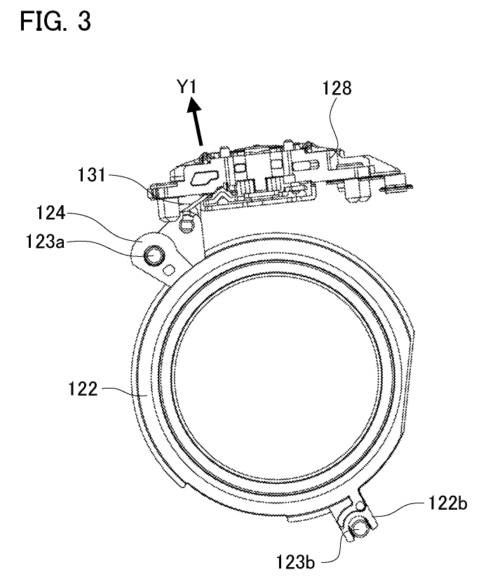

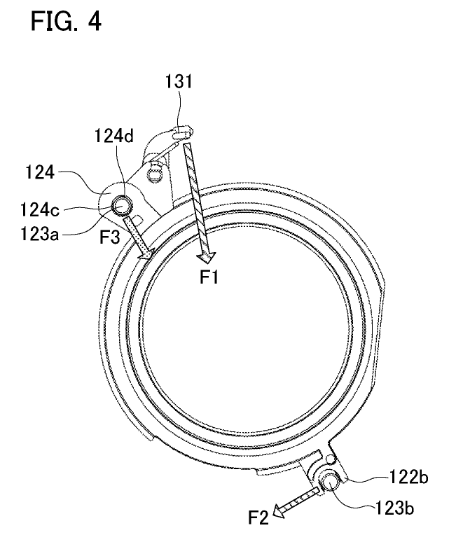

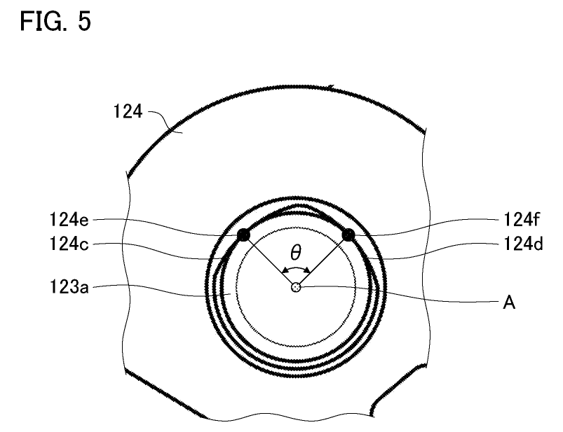

Next, a holding structure of the fourth-group lens barrel 122 in the present embodiment will be explained with reference to FIG. 2 and FIG. 5. FIG. 2 is an exploded perspective view of a configuration for driving the fourth-group lens barrel 122 in the optical axis X direction in the first embodiment. FIG. 3 is a front view, as viewed from the subject side, of a configuration for driving the fourth-group lens barrel 122 in the optical axis X direction in the first embodiment. FIG. 4 is a front view, as viewed from the subject side, of a configuration for driving the fourth-group lens barrel 122 in the optical axis X direction, excluding the linear ultrasonic motor 127, in the first embodiment. FIG. 5 is an enlarged view of contact points of the guide member 123a and a linear guide unit (guided unit) 124 in the first embodiment.

A rack (connecting member) 131 is inserted between rack shaft holes 122a of the fourth-group lens barrel 122 by passing a shaft portion 131a through a rack spring 132, and is rotatably held about an axis of the shaft portion 131a. In addition, a hook portion 132a of the rack spring 132 is hooked on the rack 131, and an extension portion 132b on the opposite side is inserted into a spring hook hole 122c provided in the fourth-group lens barrel 122. By doing so, the rack 131 is constantly urged in the Y1 direction shown in FIG. 3 about the axis of the shaft portion 131a. That is, the rack spring 132 functions as an urging member that performs urging between the fourth-group lens barrel 122 and the guide member 123a (between a moving holding frame and a guide unit).

The rack 131 has a V-groove portion 131b at a tip thereof that is always engaged with a projection portion (not shown) provided on the movable portion 126 of the linear ultrasonic motor 127. By adopting such a configuration, even if there is variation in component accuracy, it is possible to transmit a drive force of the linear ultrasonic motor 127 to the fourth-group lens barrel 122 without play using an urging force. That is, the rack 131 transmits a drive force from the linear ultrasonic motor 127 that functions as an actuator to the fourth-group lens barrel 122 that is a moving holding frame.

The guide member 123a and the guide member 123b each have both ends fixed to the third-group base lens barrel 120. In the present embodiment, the guide member 123a and the guide member 123b are each formed to have a cylindrical shape. The guide member 123a engages with an engagement portion 124a and an engagement portion 124b of the linear guide unit 124 provided in the fourth-group lens barrel 122, and holds the fourth-group lens barrel 122 movably in the optical axis X direction. Via a rotation restriction portion 122b of the fourth-group lens barrel 122, the guide member 123b prevents rotation of the fourth-group lens barrel 122 around the guide member 123a.

Next, the shape of the engagement portion 124a will be explained. In a view in the optical axis X direction, because the shape of the engagement portion 124b is the same as the shape of the engagement portion 124a, explanation thereof is omitted. The engagement portion 124a and the engagement portion 124b are provided at predetermined intervals in a direction along the optical axis. For example, here, the guide member 123a and the linear guide unit 124 are engaged at positions of the engagement portion 124a and the engagement portion 124b (engagement positions). Two or more engagement positions may be provided.

As shown in FIGS. 3, 4, and 5, the engagement portion 124a contacts the guide member 123a at a contact surface 124c (first contact surface) and at a contact surface 124d (second contact surface). That is, the linear guide unit 124 provided in the fourth-group lens barrel 122 contacts the guide member 123a and guides the fourth-group lens barrel 122 along the optical axis X direction.

As described above, the rack 131 is always urged in the arrow Y1 direction of FIG. 3 by the rack spring 132, and the linear ultrasonic motor 127 is held by the third-group base lens barrel 120. Therefore, as shown in FIG. 4, the fourth-group lens barrel 122 receives a first force F1, parallel to a normal direction of a contact surface between the rack 131 and the linear ultrasonic motor 127, that is exerted on the fourth-group lens barrel 122 by the rack spring 132. Furthermore, the fourth-group lens barrel 122 receives a second force F2 that the rotation restriction portion 122b receives from the guide member 123b, the second force F2 being parallel to a normal direction of a contact surface between the guide member 123b and the rotation restriction portion 122b. By a resultant force F3 of the first force F1 and the second force F2, each of the contact surface 124c and the contact surface 124d is urged toward the guide member 123a.

In this manner, the rack spring 132 that is an urging member performs urging between the fourth-group lens barrel 122 and the guide member 123, and between the fourth-group lens barrel 122 and the linear ultrasonic motor 127 (between a moving holding frame and an actuator). Accordingly, even if the gravity direction changes due to a posture change of the image capturing system 1, stable urging of the fourth-group lens barrel 122 toward the guide member 123a becomes possible.

In addition, the contact surface 124c and the contact surface 124d each have curvature. The curvature of the contact surface 124c and the curvature of the contact surface 124d are set so as to be smaller than the curvature of the guide member 123a that is formed in a cylindrical shape. It should be noted that, at least, the curvature of the contact surface 124c and the curvature of the contact surface 124d need only be smaller than the curvature of each contact surface (the third contact surface and the fourth contact surface) of the guide member 123a that contact the contact surface 124c and the contact surface 124d. Accordingly, in comparison to a case in which the contact surfaces are flat, it is possible to reduce the contact surface pressure against the guide member 123a, suppress occurrence of scraping of the lens barrel, grease shortage, and the like due to long-term use, and improve durability.

In this context, when viewed from the optical axis X direction, a center angle θ with respect to an arc center A of the guide member 123a for a contact point 124e between the guide member 123a and the contact surface 124c and a contact point 124f between the guide member 123a and the contact surface 124d is equal to or greater than 30 degrees and equal to or less than 135 degrees. In a case in which the center angle θ is small, much urging force becomes necessary in order to keep the contact point 124e and the contact point 124f constant regardless of posture differences. In order to increase urging force of the contact surface 124c and the contact surface 124d with respect to the guide member 123a, if a spring force of the rack spring 132 is increased, the urging force of a rotation restriction portion 122b with respect to the guide member 123b also increases. As a result, load during driving increases, and durability deteriorates. In contrast, in a case in which the center angle θ is large, the guide member 123a is tightly clamped and becomes a load during driving.

Accordingly, in the present embodiment, the curvature of the contact surface 124c (the first contact surface) and the curvature of the contact surface 124d (the second contact surface) are set so that the center angle θ is equal to or greater than 30 degrees and equal to or less than 135 degrees. In addition, in the present embodiment, as described above, the guide member 123a and the linear guide unit 124 are in contact at two points, the two points being the contact point 124e that is a contact point between the guide member 123a and the contact surface 124c, and the contact point 124f that is a contact point between the guide member 123a and the contact surface 124d.

The materials of the fourth-group lens barrel 122 and the guide member 123a may, for either one or for each, be resin or be metal. In other words, regardless of whether the material of each of the fourth-group lens barrel 122 and the guide member 123a is resin or metal, effects similar to those of the present embodiment are obtained.

In the present embodiment, the guide member 123a is formed in a cylindrical shape so as to have curvature. However, at least each contact surface of the guide member 123a that contacts the contact surface 124c and each contact surface of the guide member 123a that contacts the contact surface 124d need only have curvature. In other words, if each contact surface of the guide member 123a that contacts the contact surface 124c and each contact surface of the guide member 123a that contacts the contact surface 124d has curvature, the guide member 123a is not limited to a cylindrical shape. For example, in a case of a rod-shaped guide member, if contact surfaces that contact the contact surface 124c and the contact surface 124d have curvature, that is, are arc-shaped, the guide member 123a may be of another shape. It should be noted that even in a case in which only each contact surface of the guide member 123a that contacts the contact surface 124c and the contact surface 124d has curvature as described above, the curvature of the contact surface 124c and the contact surface 124d is smaller than the curvature of each corresponding contact surface in the guide member 123a.

In addition, in the present embodiment, although an ultrasonic motor is adopted to drive the fourth-group lens barrel 122, a drive unit such as a step motor or a voice coil motor may be adopted.

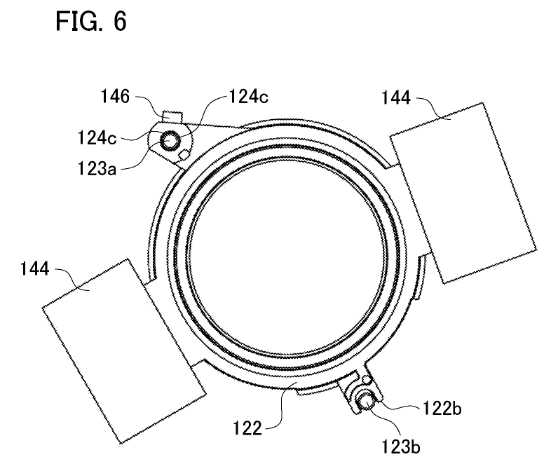

FIG. 6 is a perspective view showing a modification example of an urging unit of the fourth-group lens barrel 122 for urging toward the guide member 123a in the first embodiment. The fourth-group lens barrel 122 is driven by a voice coil motor 144 and is magnetically urged toward the guide member 123a by an urging member 146. In addition, the urging member 146 is disposed at a position capable of urging each of the contact surface 124c and the contact surface 124d in a direction toward the guide member 123a. By disposing the urging member 146 in the fourth-group lens barrel 122 so as to be at the position capable of urging each of the contact surface 124c and the contact surface 124d in a direction toward the guide member 123a, the urging member 146 can magnetically urge each of the contact surface 124c and the contact surface 124d in a direction toward the guide member 123a.

In the first embodiment, urging is performed by the rack spring 132 between the guide member 123a and the linear guide unit 124, between the guide member 123b and the rotation restriction portion 122b, and between the rack 131 and the linear ultrasonic motor 127. However, as in the modification example, similar effects occur even if an urging member that performs urging between the guide member 123a and the fourth-group lens barrel 122 is provided independently.

As described above, by adopting the configuration of the first embodiment, it is possible to provide a lens barrel that has improved durability while stable urging is performed in various postures.

### Second Embodiment

Hereinafter, an image capturing system 1 having a lens barrel 10 according to the second embodiment is explained. With respect to configurations other than a configuration of a fourth-group lens barrel 222 and with respect to drive methods of each lens group, since the configurations and the drive methods are similar to the first embodiment, explanations are omitted.

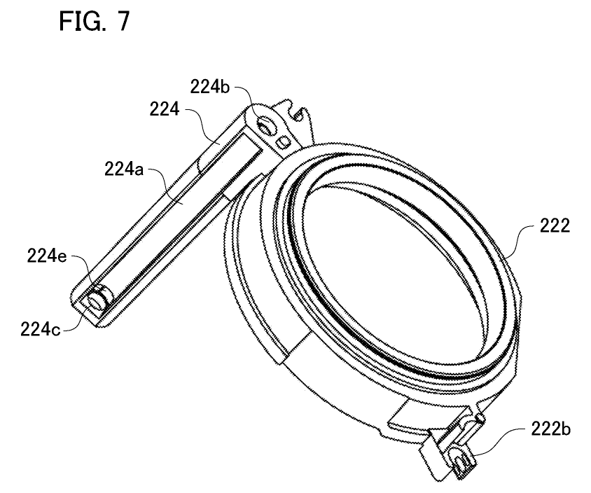

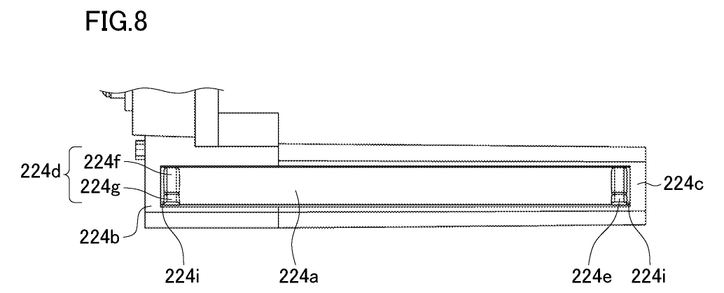

FIG. 7 is a perspective view of the fourth-group lens barrel 222 in a second embodiment. FIG. 8 is a side view of a linear guide unit 224 in the second embodiment. As shown in FIGS. 7 and 8, the linear guide unit 224 includes an opening portion 224a in which an opening is formed in a direction along the optical axis X. The opening portion 224a has, at one end portion, an engagement portion 224b (first hole) through which the guide member 123a is inserted, and, at the other end portion, an engagement portion 224c (second hole). That is, the opening portion 224a is disposed between the engagement portion 224b and the engagement portion 224c so as to be separated in the direction along the optical axis X. Furthermore, a contact portion 224d and a contact portion 224e that contact the guide member 123a are provided (formed) within a disposition range in the optical axis X direction in which the opening portion 224a is disposed. In addition, similar to the first embodiment, a rotation restriction portion 222b is provided in the fourth-group lens barrel 222.

In the second embodiment, the contact portions (224d, 224e) and the engagement portions (224b, 224c) are each provided independently. Accordingly, in the linear guide unit 224 of the second embodiment, groove portions 224i are formed between each contact portion and the corresponding engagement portion. That is, in a direction along the optical axis X, one groove portion 224 is formed between the engagement portion 224b and the contact portion 224d, and another groove portion 224 is formed between the engagement portion 224c and the contact portion 224e.

By forming a groove portion 224i, it becomes possible to release burrs generated by mold parting during molding, and increases in sliding load and damage to the guide member 123a can be prevented. Furthermore, the groove portion 224i is also utilized as a lubricant reservoir. In other words, the groove portion 224i holds lubricating oil. Lubricant held in the groove portion 224i adheres to the guide member 123a that is positioned in the groove portion 224i. Then, in association with movement of the fourth-group lens barrel 122, excess lubricant is removed by the contact portion 224d and the contact portion 224e and is returned to the groove portion 224i. As a result, an appropriate amount of lubricant for smooth movement of the fourth-group lens barrel 122 is maintained at contact points of the guide member 123a and the linear guide unit 124. In this manner, the groove portion 224i functions as a portion that is capable of holding lubricating oil used for the guide member 123. Accordingly, it becomes possible to improve durability compared to a case in which the contact portions and the engagement portions are provided at the same position in the optical axis X direction.

In addition, because the contact portion 224d and the contact portion 224e are formed in a range in the optical axis X direction in which the opening portion 224a is disposed, during molding, shapes of the contact portion 224d and the contact portion 224e can be formed by forming the opening portion 224a using one slide. A contact surface 224f and a contact surface 224g of the contact portion 224d that contact the guide member 123a are formed parallel to the optical axis X. Therefore, in a case in which the contact portions and the engagement portions are provided at the same position in the optical axis X direction, the contact portions are formed by forcibly extracting the mold in the optical axis X direction. In contrast, in a case in which the contact portions are formed simultaneously using a slide that forms the opening portion 224a, because an extraction direction of a mold does not coincide with the optical axis X direction, forced extraction becomes unnecessary, and durability of a mold can be improved.

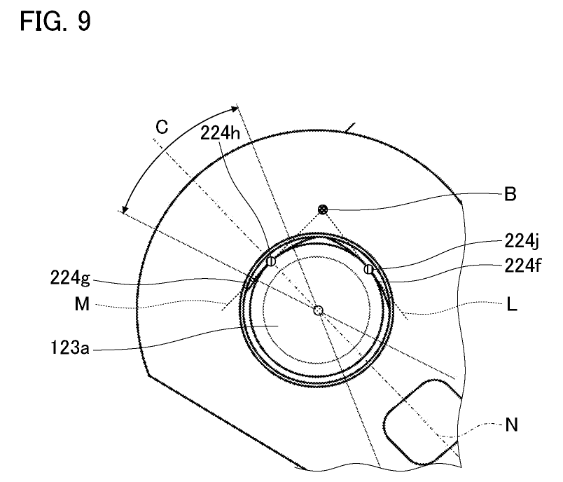

Next, the contact portion 224d of the second embodiment will be explained. In a view in the optical axis X direction, the shape of the contact portion 224e is similar to the shape of the contact portion 224d, and therefore explanation thereof is omitted. FIG. 9 is an enlarged view of contact points of the guide member 123a and the linear guide unit 124 in the second embodiment.

As shown in FIG. 9, the guide member 123a contacts the contact portion 224d at the contact surface 224f and the contact surface 224g. Since the shapes of the contact surface 224f and the contact surface 224g and the effects thereof are similar to the first embodiment, explanation thereof is omitted.

Region C shown in FIG. 9 is, from among a region of ±15 degrees from the straight line N that passes through the arc center A of the guide member 123a and the optical axis X, taking the arc center A as the center (origin), the region that is separated from the optical axis X. At this time, the contact surface 224f and the contact surface 224g are formed so that an intersection point B of a tangent line L at a contact point 224j between the guide member 123a and the contact surface 224f and a tangent line M at a contact point 224h between the guide member 123a and the contact surface 224g exists in a range other than Region C. That is, when viewed from a direction along the optical axis X, the intersection of tangent lines at the two contact points of the contact surface 224f and the contact surface 224g that contact the guide member 123a exists at a location other than the region that is separated from the optical axis within a region of ±15 degrees from a line connecting the optical axis and the origin, taking the above arc center as the origin. Accordingly, interference is not caused between an extraction direction of a slide that forms the opening portion 224a and the fourth-group lens barrel 222, and molding becomes possible.

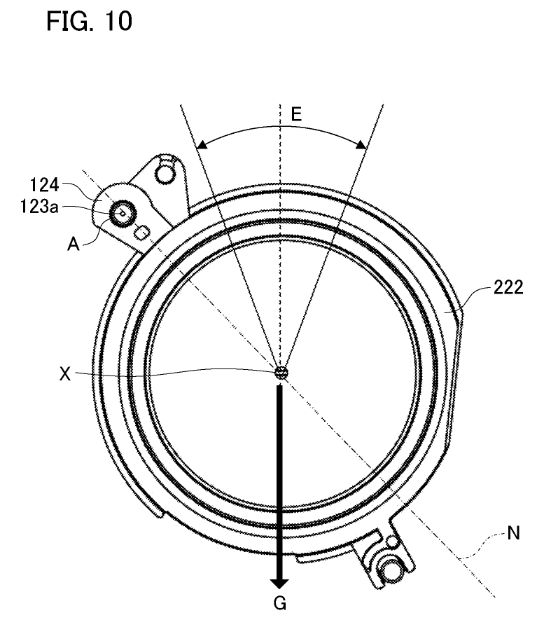

Next, a disposition range of the linear guide unit 224 will be explained with reference to FIG. 10. FIG. 10 is a front view of the fourth-group lens barrel 222 in a posture D of a lens barrel 10 mounted on a camera body 20 in a posture in which an operation unit disposed on an upper portion of the camera body 20 in the second embodiment faces a vertically upward direction. An arrow G indicates a direction of gravity. In posture D, the linear guide unit 224 is disposed such that the arc center of the guide member 123a, when viewed from a direction along the optical axis X, exists in a range outside ±15 degrees from the vertically upward (directly upward) direction about the optical axis X, that is, outside Region E.

When the direction of gravity in the posture D coincides with an urging direction of the linear guide unit 224 toward the guide member 123a, stable urging can be performed with a smaller urging force in the posture D and in postures at ±90 degrees about the optical axis from the posture D. At this time, because the arc center A of the guide member 123a exists outside the region E, the fourth-group lens barrel 222 does not interfere with an extraction direction of a slide that forms the opening portion 224a, and molding becomes possible.

As described above, in the configuration of the second embodiment as well, similar to the first embodiment, a lens barrel having improved durability while performing stable urging in various postures can be provided.

In each of the above-described embodiments, although explanations were provided with respect to an interchangeable lens for performing still image shooting and moving image shooting, similar effects may also be obtained, for example, in a lens barrel that records images. In addition, in each of the above-described embodiments, application is possible not only to a focus lens within a lens barrel but also to another lens that moves during zooming.

### Other Embodiments

As described above, although embodiments of the present disclosure have been explained, the present disclosure is not limited to these embodiments, and various modifications and changes are possible within a scope of the gist thereof. In addition, the above-described embodiments may be implemented in combination.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220093, filed December 16, 2024, which is hereby incorporated by reference herein in its entirety.

What is claimed is:

1. An optical apparatus comprising:
a holding unit configured to hold an optical element and to be movable in an optical axis direction;
a guide unit configured to guide movement of the holding unit; and
an urging member configured to urge the holding unit and the guide unit toward each other,
wherein the holding unit includes a first contact surface and a second contact surface that contact the guide unit in a direction perpendicular to the optical axis direction;
a curvature of the first contact surface is smaller than a curvature of a third contact surface in the guide unit that contacts the first contact surface; and
a curvature of the second contact surface is smaller than a curvature of a fourth contact surface in the guide unit that contacts the second contact surface.

2. The optical apparatus according to claim 1, further comprising:
a drive unit configured to move the holding unit in the optical axis direction; and
a connecting member configured to transmit a drive force of the drive unit to the holding unit,
wherein the urging member is configured to perform urging between the holding unit and the guide unit, and urging between the holding unit and the drive unit.

3. The optical apparatus according to claim 1, wherein the urging member is configured to urge the first contact surface and the second contact surface in a direction toward the guide unit.

4. The optical apparatus according to claim 1, wherein, when viewed from the optical axis direction, a center angle, based on an arc center of the guide unit, of a contact point of the guide unit and the first contact surface and a contact point of the guide unit and the second contact surface is equal to or greater than 30 degrees and equal to or less than 135 degrees.

5. The optical apparatus according to claim 1, wherein the urging member is configured to urge by magnetism each of the first contact surface and the second contact surface in a direction toward the guide unit.

6. The optical apparatus according to claim 1, wherein:
the holding unit comprises a guided unit that contacts the guide unit and is guided in the optical axis direction;
the guided unit has a first hole through which the guide unit is inserted and a second hole disposed to be spaced apart from the first hole in the optical axis direction;
the guided unit has an opening portion between the first hole and the second hole in the optical axis direction; and
the first contact surface and the second contact surface are provided within a disposition range in the optical axis direction of the opening portion.

7. The optical apparatus according to claim 6, wherein in the optical axis direction, groove portions are formed between the first hole and the first contact surface and between the second hole and the second contact surface.

8. The optical apparatus according to claim 7, wherein the groove portions are configured to hold lubricating oil used in the guide unit.

9. The optical apparatus according to claim 1, wherein, when viewed from the optical axis direction and taking an arc center of the guide unit as the origin, an intersection of a tangent lines at a contact point of the guide unit and the first contact surface and at a contact point of the guide unit and the second contact surface exists in a region other than a region separated from the optical axis within ±15 degrees from a line connecting the optical axis and the origin.

10. The optical apparatus according to claim 1, wherein in a posture of the optical apparatus configured to be mountable on an image capturing apparatus in a posture in which an operation unit disposed on an upper portion of the image capturing apparatus faces the vertically upward direction, when viewed from the optical axis direction, the center of the guide unit is disposed in a range other than ±15 degrees from the vertically upward direction about the optical axis.

11. The optical apparatus according to claim 6, wherein the guide unit and the guided unit are in contact at two contact points, the two contact points being a contact point between the guide unit and the first contact surface and a contact point between the guide unit and the second contact surface.

12. The optical apparatus according to claim 11, wherein the guide unit and the guided unit engage at at least two positions provided at predetermined intervals in the optical axis direction, and the guide unit and the guided unit are in contact at two points at each of the engagement positions.

13. The optical apparatus according to claim 1, wherein the optical apparatus is configured to be attachable to and detachable from an image capturing apparatus.

14. An image capturing system comprising:
the optical apparatus according to claim 1; and
an image capturing element.
